(19) United States
(12) Patent Application Publication
(10) Pub. No.: US 2026/0248666 A1
(43) Pub. Date: Aug. 27, 2026

(54) A Wheelchair

(71) Applicant: Rolapal Limited, Auckland (NZ)

(72) Inventors: Roydon Scarlett, Auckland (NZ); Roydon Scarlett

(21) Appl. No.: 19/163,108

(22) PCT Filed: Jan. 25, 2024
(86) PCT No.: PCT/NZ2024/050008

§ 371 Date: Sep. 8, 2025

(30) Foreign Application Priority Data
Mar. 9, 2023 (AU) 2023201472

(51) Int. Cl. A61G 5/10; A61G 5/08

(52) U.S. Cl. CPC A61G 5/1075; A61G 5/0833; A61G 5/0866; A61G 5/0875; A61G 5/0883; A61G 5/107; A61G 2203/70

(57) ABSTRACT

A wheelchair comprising a seat module 12 having a pair of seat rails. Each seat rail 33 is fitted with a resilient hook or groove 48 at or adjacent a rear end of the rail 33 and a forward seat locking component 45. The wheelchair also has a chassis module 11 having a pair of chassis rails 18. Each chassis rail 18 is fitted with a laterally disposed receiving pin 23 and a forward chassis locking component 26. The wheelchair also has a pair of cam levers 28. The arrangement of these parts is such that the seat module can be manoeuvred by hand so that the hooks or grooves 48 engage the pins 23 to form pivots, the seat module can then be swung down by hand about the pivots to cause each seat locking component 45 to contact a respective one of the chassis locking components 26; and the cam levers 28 can then be manipulated by hand to cause the seat locking components 45 and the chassis locking components 26 to be releasably cam locked to one another. This enables the seat and chassis modules to be releasably locked to one another.

### FIELD OF THE INVENTION

This invention relates to a wheelchair.

### BACKGROUND

The invention preferably has particular application to tilt-in-space wheelchairs. These are used to prevent pressure points between the body of a human user and the chair, and to provide the chair occupant with a rest position. Such wheelchairs tend to be bulky and difficult to transport, especially in vehicle boots or luggage compartments. To make the wheelchair less bulky for transportation it is known to have parts that are able to be quickly released or removed. These may include leg rests, arm rests and rear wheels. It is also known for the backrest canes to be releasably locking, and able to fold down to the seat for compact storage or transport. While these features go some way to reducing the physical size of the wheelchair it often remains inconvenient to get into a compact form and may remain bulky and heavy.

### OBJECT

It is an object of a preferred embodiment of the invention to go at least some way towards addressing one or more of the above problems. However, it should be understood that the object of the invention per se is not so specific. It is simply to provide the public with a useful choice.

### DEFINITIONS

The term “comprises” or “has”, if and when used in this document in relation to a combination of features, should not be seen as excluding the option of additional features in the combination that are not mentioned.

Orientational terms as used in this specification, for example “forward” or “rear”, indicate the position of the item referenced when in a normal in-use disposition. However, it should not be taken from this that the claims are limited to a wheelchair when in that position.

### SUMMARY OF THE INVENTION

The invention is preferably a wheelchair comprising:
a) a seat module having a pair of seat rails, each seat rail being fitted with:
   a resilient hook or groove at or adjacent a rear end of the rail; and
   a forward seat locking component;
b) a chassis module having a pair of chassis rails, each chassis rail being fitted with:
   a laterally disposed receiving pin; and
   a forward chassis locking component; and
c) a pair of cam levers;
the arrangement of the above parts being such that:
d) the seat module can be manoeuvred by hand so that the hooks or grooves engage the pins to form pivots;
e) the seat module can be swung down by hand about the pivots to cause each seat locking component to contact a respective one of the chassis locking components; and
f) the cam levers can then be manipulated by hand to cause the seat locking components and the chassis locking components to be releasably cam locked to one another such that the seat and chassis modules are also releasably locked to one another.

Optionally each receiving pin forms part of, or is mounted to its respective chassis rail by way of, a bracket or a pair of mounting plates.

Optionally each seat locking component extends downwards from its respective seat rail, and each chassis locking component extends upwards from its respective chassis rail.

Optionally each seat locking component has a recess into which a respective one of the cam levers is able to be releasably cam locked.

Optionally each cam lever is secured to or is integral with a respective one of the chassis locking components.

Optionally each chassis locking component has a rear facing ramped surface which contacts a respective one of the seat locking components when the seat module is swung as noted at claim 1 part e).

Optionally each seat locking component has a bifurcated lower end into which a support of the respective cam lever is slot fitted when the seat module is swung as noted at claim 1 part e).
a) the backrest module comprises a pair of backrest canes, and each cane has a transverse seat hook or groove at an end thereof; and
b) each seat rail is fitted with a laterally extending seat pin;
   the arrangement of these parts being such that when the seat and chassis modules are locked to one another the canes can be rotated to cause the seat pins to swing into engagement with the seat grooves or hooks to assist in releasably retaining the canes in an upright disposition for supporting the back of a human user of the wheelchair.

Optionally in each case the seat pin forms part of, and is mounted to its respective seat rail by way of, a bracket or a pair of mounting plates.

Optionally each hook or groove is substantially resilient.

Optionally each hook or groove provides for a snap fit engagement with a respective one of the pins.

### DRAWINGS

Some preferred embodiments will now be described by way of example and with reference to the accompanying drawings, of which—

FIG. 1 is an isometric view of the frame of a wheelchair;

FIG. 2 is a side elevation view of the wheelchair frame;

FIG. 3 is an isometric view of the wheelchair frame when folded down, after some parts have been detached;

FIG. 4 is a side elevation view of the wheelchair frame of FIG. 3;

FIG. 5 is an isometric view of the wheelchair frame with its seat module partially removed from its chassis module;

FIG. 6 is side elevation view of the wheelchair frame of FIG. 5,

FIG. 7 is a side elevation view of the chassis module;

FIG. 9 is an isometric view of the seat module in its folded configuration when removed from the chassis module;

FIG. 10 is side view of the seat module of FIG. 9;

FIG. 11 is an isometric view of a preferred form of the front part of an arrangement for locking the seat module to the chassis module; and

FIG. 12 is an isometric view of a preferred rear receiver part of the locking arrangement.

### DETAILED DESCRIPTION

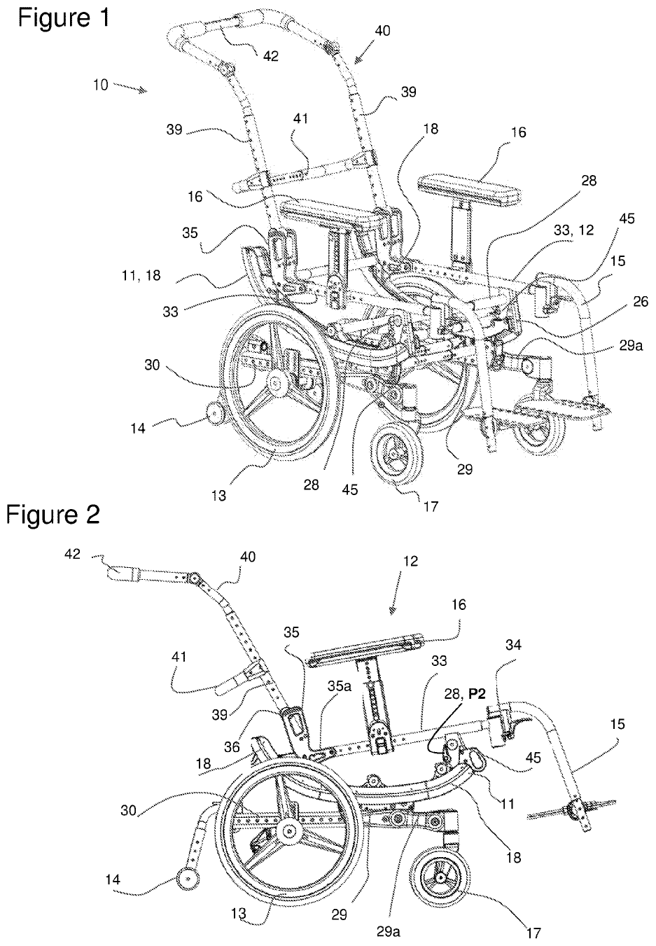

Referring to FIGS. 1-4, the wheelchair is of a fold-up tilt-in-space type. For ease of explanation, the seat and backrest upholstery have been omitted from the drawings.

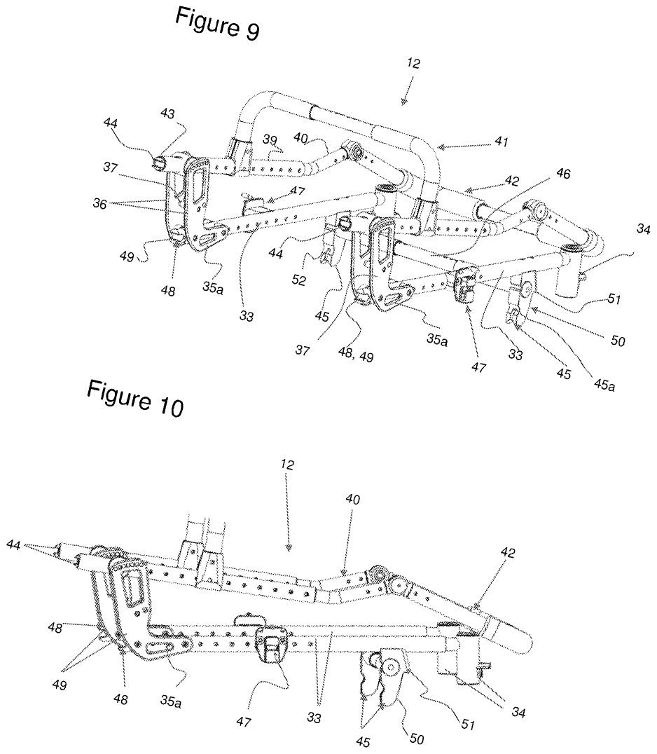

The wheelchair comprises a lower chassis module 11 (see for example FIGS. 6, 7 and 8) and an upper seat module 12 (see for example FIGS. 9 and 10). These modules are, in the assembled wheelchair, coupled together by a quick release locking arrangement. The seat module 12 can therefore be readily removed from the chassis module 11. This enables the wheelchair mass and weight to be divided more or less evenly for ease of transport and storage.

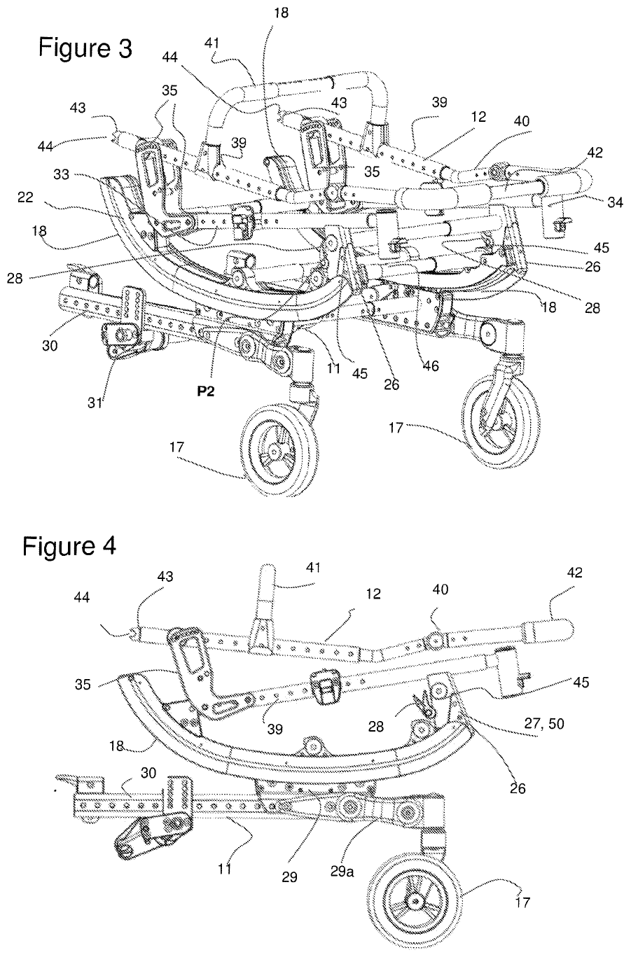

Referring to FIGS. 1 and 2, the wheelchair includes a pair of large rear wheels 13, smaller rear stabilizing wheels or skids 14, leg rests 15 and arm rests 16, all of which are readily removable by way of quick release locking assemblies to assist in making the wheelchair less bulky for transportation. After the seat module 12 has been folded into a compacted configuration as per FIG. 3, the chassis and seat modules 11 and 12 can be uncoupled.

Still with FIGS. 1 and 2, for the wheelchair's normal in use orientation, the rear of the wheelchair frame 10 is where the rear stabilizing wheels/skids 14 are located, and the front of the frame 10 is where the castor wheel assemblies 17 are located.

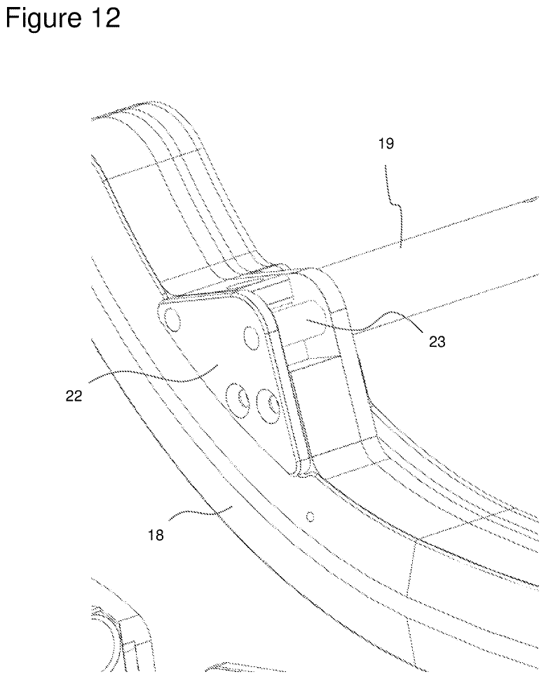

As shown in FIG. 8, the chassis module 11 includes arcuate shaped parallel side rails 18 (eg bars) that are held spaced apart by cross bars 19, 20 and 21. Towards the rear end of each of the side rails 18 is an upstanding mount 22. A cross bar 19 spans between the mounts 22. Each mount 22 is bifurcated and incorporates a receiver pin 23 (the pin 23 is best seen in FIG. 12). In other embodiments the rails may be straight or some other non-actuate

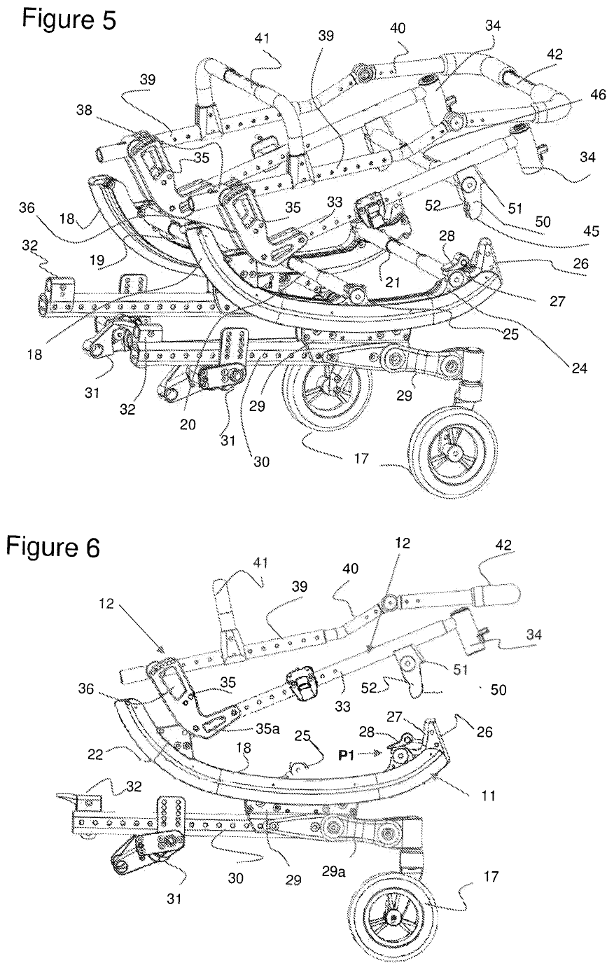

Referring to FIGS. 5 & 6, at about the forward end of each side rail 18 is a mount 24 and the cross bar 21 spans between these mounts 24. Similarly, the intermediate cross bar 20 spans between mounts 25 that are also attached to the side rails 18. The cross bars 19, 20 and 21 (together with the cross bars of the back rest) are able to be length adjusted (eg they may be telescoping) to enable adjustment of the width of the wheelchair.

Still with FIG. 5, the front end of each of the side rails 18 has an upstand bracket 26 that has a profiled rear facing ramped surface 27. Spaced from and facing the profiled surface 27 is a cam-lock lever 28.

With further reference to FIG. 5, a mount 29 projects downwardly from the under surface of each side rail 18. In each case this mount 29 has a bifurcated portion into which is linearly-adjustably attached a rearwardly extending arm 30 to which is coupled a linearly-adjustable wheel attachment assembly 31 for removably mounting the wheel 13. At the distal rear end of the arm 30 is a linearly-adjustable quick release assembly 32 for removably coupling the stabilizing wheel/skid 14 to the arm 30. In each case the mount 29 also provides the means of adjustably attaching an arm 29a of the front castor wheel assembly 17.

Still with FIG. 5, the seat module 12 has a pair of spaced apart parallel side rails, eg bars 33. At the front end of each side bar 33 is a mount 34 for a leg rest 15. At the rearward end of each side bar 33 is a pair of linearly-adjustable “L” shaped plates 35. The foot portion 35a of each L shaped plate 35 is attached to respective opposite sides of the side bar 33 so that the leg portions 36 of the plates 35 project upwardly. A pin 37 (best seen in FIG. 9) is mounted to extend transversely/sideways between the leg portions 36.

As also shown in FIGS. 5 and 6, at each side, and pivotally attached between the upper end of each plate 35, is a cylindrical mount 38 through which is engaged one end of a backrest cane 39 that forms part of the backrest 40. The backrest canes 39 are held in a spaced relationship by a substantially “U” shaped cross bar 41 and by a handle assembly 42 that is coupled to and spans between the backrest canes 39.

Referring to FIG. 4, in each case the end of the backrest cane 39 that projects through the cylindrical mount 38 has an insert 43 made from a resilient material. A transverse hook or groove 44 is part of the insert 43 so that when the backrest is moved up from its folded position as shown in FIGS. 9 and 10 the insert 43 can resiliently deform sufficiently for the pin 37 to move into the groove 44 and be snug there to retain the backrest 40 in its upright position. Optionally the connection is a releasable snap fit type. Equally the backrest/handle assembly can be folded down by applying a pressure that would not be incurred to the backrest 40 in normal use, to force the pin 37 and insert 43 to disconnect/unlock.

As also shown in FIGS. 9 and 10, on each side bar 33, behind the forward mount 34, is a downwardly projecting lock element 45. A cross bar 46 extends between the lock elements 45 for strength and stability. Also located on each side bar 33, between the lock element 45 and the L shaped plates 35, is a mount 47 for the removable attachment of the arm rests 16. The positions of each lock element 45 and mount 45 may be adjusted linearly along its associated side bar 33.

Still with FIGS. 9 and 10, at the rearward end of each side bar 33 there is a slot or hook element 48 which is located between the L shaped plates 35. The rearward facing recess 49 of the hook element 48 is of substantially “U” shaped cross section and extends transversely/sideways with respect to the longitudinal dimension of the side bar 33. Optionally the hook 48 element is resilient for snap-fitting.

### Fitting of the Modules

The seat module 12 is fitted to the chassis module 11 by engaging (optionally snap fitting) the hook elements 48 of the seat module (see FIG. 9) with the respective receiver pins 23 of the chassis module (see FIG. 8). The seat module 12 is then rotated downwardly about the axis of the hinges formed by the hook elements 48 and receiver pins 23. This results in the downwardly extending lock elements 45 (see FIG. 9) of the seat module engaging with the upstands 26 (see FIG. 6) of the chassis module 11. The forward-facing surface 50 of the lock element 45 may be profiled to compliment the shape of the rearward facing surface 27 of the upstand 26 so that a snug face to face contact is formed between the two. The lock engagement element 45 has an abutment surface or step 51 that engages with the top of the upstand 26.

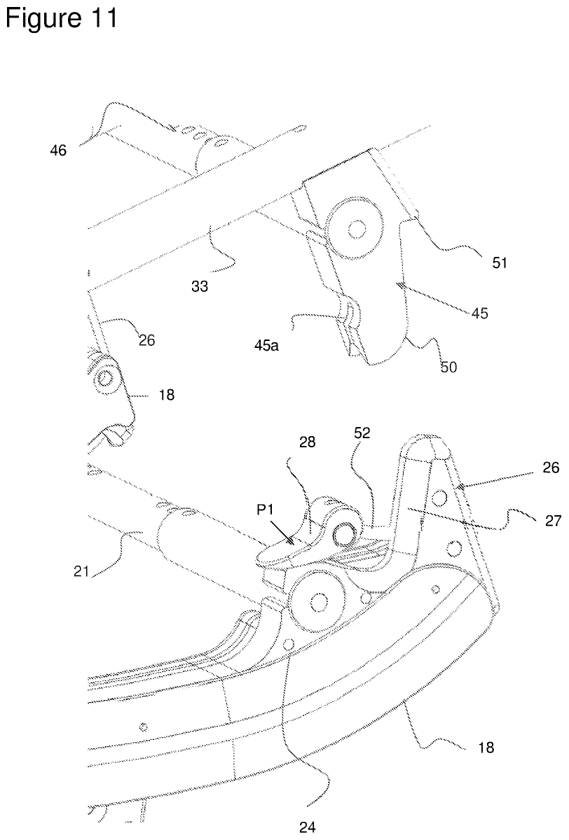

Referring to FIG. 11, the lock engagement element 45 has a bifurcated (eg forked) leading end that provides a clearance for an arm 52 that extends from the upstand 26 and to which the cam-lock lever 28 is rotatably coupled. FIG. 11 shows this arm and also the lock-cam lever in its release position (position P1).

FIG. 12 illustrates detail of part of the chassis module, including close-up detail for the pin 23

When the seat module 12 has been lowered down so that the lock engagement element 45 and upstand 26 are engaged face to face, the cam-lock lever 28 (see FIG. 11) can be rotated from position P1 to locking position P2 (see for example FIGS. 2 and 3) to engage with the groove 45a (see FIG. 9) in the lock element 45 and thereby lock the seat module 12 to the chassis module 11.

The substantially arcuate shaped side rails 18 provides for adjustable optimum positioning of the upstands 26 and the effective pivot axis of the receiver pins 23 and hook elements 48 so that a robust yet quick release coupling of the seat module 12 to the chassis module 11 is achieved. The arcuate shape of the rails 18 also provides for tilt adjustment for the seat module. can then be fitted to the seat module 12 and the wheels 13 and the rear stabilizing wheels/skids 14 attached to the chassis module 11.

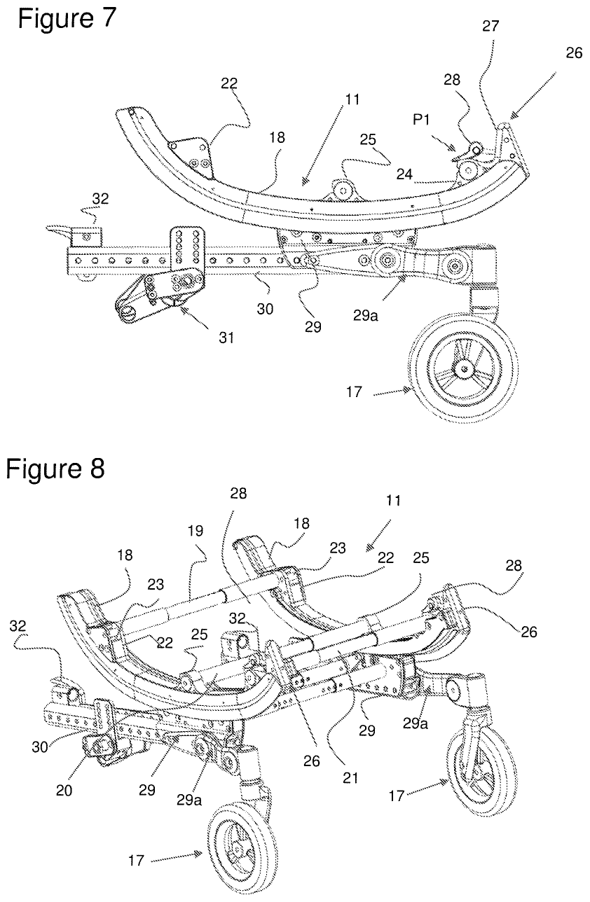

When the wheelchair is to be compacted for transportation the wheels 13, wheels/skids 14, leg rest 15 and arm rests 16 may be removed, and the back rest 40 moved to its collapsed position (see FIG. 3). After the cam-lock lever 28 has been moved to its release position P1, the seat module 12 can be tilted upwards (see FIGS. 5 and 6) and then moved sufficiently forward for the grooves 44 and receiver pins 23 to disengage, at which point the seat module 12 can be separated from the chassis module 11. FIGS. 7 and 8 show the chassis module 11 after the seat module 12 has been removed.

As will be appreciated, the configuration of the wheelchair frame is adjustable in the width, angle and height of the handle assembly 42, the position of the axis of rotation of the wheels 13, the height of leg rests 15 and arm rests 16, and the angle of the backrest canes 39 relative to the seat module side bars 33.

While some forms of the invention have been described by way of example, it should be appreciated that modifications and improvements can be made without departing from the scope of the following claims.

In terms of disclosure, this document envisages and hereby posits any feature mentioned herein in combination with itself or any other feature or features mentioned herein, even if the combination is not claimed.

1. A wheelchair comprising:
a) a seat module having a pair of seat rails, each seat rail being fitted with:
a resilient hook or groove at or adjacent a rear end of the rail; and
a forward seat locking component;
b) a chassis module having a pair of chassis rails, each chassis rail being fitted with:
a laterally disposed receiving pin; and
a forward chassis locking component; and
c) a pair of cam levers;
the arrangement of the above parts being such that:
d) the seat module can be manoeuvred by hand so that the hooks or grooves engage the pins to form pivots;
e) the seat module can be swung down by hand about the pivots to cause each seat locking component to contact a respective one of the chassis locking components; and
f) the cam levers can then be manipulated by hand to cause the seat locking components and the chassis locking components to be releasably cam locked to one another such that the seat and chassis modules are also releasably locked to one another.

2. A wheelchair according to claim 1, wherein each receiving pin forms part of, or is mounted to its respective chassis rail by way of, a bracket or a pair of mounting plates.

3. A wheelchair according to claim 1, wherein each seat locking component extends downwards from its respective seat rail, and each chassis locking component extends upwards from its respective chassis rail.

4. A wheelchair according to claim 1, wherein each seat locking component has a recess into which a respective one of the cam levers is able to be releasably cam locked.

5. A wheelchair according to claim 1, wherein each cam lever is secured to or is integral with a respective one of the chassis locking components.

6. A wheelchair according to claim 1, wherein each chassis locking component has a rear facing ramped surface which contacts a respective one of the seat locking components when the seat module is swung as noted at claim 1 part e).

7. A wheelchair according to claim 1, wherein each seat locking component has a bifurcated lower end into which a support of the respective cam lever is slot fitted when the seat module is swung as noted at claim 1 part e).

8. A wheelchair according to claim 1, wherein:
a) the seat module comprises a pair of backrest canes, and each cane has a transverse seat hook or groove at an end thereof; and
b) each seat rail is fitted with a laterally extending seat pin;
the arrangement of these parts being such that when the seat and chassis modules are locked to one another the canes can be rotated to cause the seat pins to swing into engagement with the seat grooves or hooks to assist in releasably retaining the canes in an upright disposition for supporting the back of a human user of the wheelchair.

9. A wheelchair according to claim 8, wherein in each case the seat pin forms part of, and is mounted to its respective seat rail by way of, a bracket or a pair of mounting plates.

10. A wheelchair according to claim 1, wherein each hook or groove is substantially resilient.

11. A wheelchair according to claim 1, wherein each hook or groove provides for a snap fit engagement with a respective one of the pins.

12. A wheelchair according to claim 1, wherein—
a) each seat locking component extends downwards from its respective seat rail, and each chassis locking component extends upwards from its respective chassis rail;
b) each seat locking component has a recess into which a respective one of the cam levers is able to be releasably cam locked;
c) each cam lever is secured to or is integral with a respective one of the chassis locking components;
d) each chassis locking component has a rear facing ramped surface which contacts a respective one of the seat locking components when the seat module is swung as noted at claim 1 part e);
e) each seat locking component has a bifurcated lower end into which a support of the respective cam lever is slot fitted when the seat module is swung as noted at claim 1 part e);
f) the seat module comprises a pair of backrest canes, and each cane has a transverse seat hook or groove at an end thereof;
g) each seat rail is fitted with a laterally extending seat pin;
h) the arrangement for items g) and h) of this claim being such that when the seat and chassis modules are locked to one another the canes can be rotated to cause the seat pins to swing into engagement with the seat grooves or hooks to assist in releasably retaining the canes in an upright disposition for supporting the back of a human user of the wheelchair; and
i) each hook or groove is substantially resilient.
